(19) United States
(12) Patent Application Publication
(10) Pub. No.: US 2011/0121029 A1
(43) Pub. Date: May 26, 2011

(54) Brace Four Health

(76) Inventor: Bernard Frances Pettingill, Palm Beach Gardens, FL (US)

(21) Appl. No.: 12/622,688

(22) Filed: Nov. 20, 2009

(51) Int. Cl. B67D 7/84

(52) U.S. Cl. 222/129; 222/175; 222/94

(57) ABSTRACT

Elastic/adjustable wrist band with available multiple cells of alcohol, sanitizing agents and moisturizer treatments to sanitize ones hands in the absence of hand washing, which will help reduce or minimize the spread of infection.

### B. CROSS-REFERENCE TO RELATED APPLICATIONS

Powers, et al (7,135,011); Mahaffey, et al (6,283,334); Villaveces (5,927,548); Maignan, et al (4,956,175); Narula et al (6,617,294).

### C. STATEMENT REGARDING FEDERALLY SPONSORED RESEARCH OR DEVELOPMENT

Not Applicable

### D. THE NAMES OF THE PARTIES TO A JOINT RESEARCH AGREEMENT

Not Applicable

### E. INCORPORATION-BY-REFERENCE OF MATERIAL SUBMITTED ON A COMPACT DISC

Not Applicable

### F. BACKGROUND OF THE INVENTION

(1) Field of the Invention

Throughout Hospitals, Schools, Governmental Agencies, Court Rooms, Shopping Malls and other public environments, hand washing is not always properly maintained to prevent unsanitary conditions. This lack of hand washing cleanliness can increase the likely hood of infection (H1N1, MRSA, Flu, etc.) due to contacting contaminated surfaces with your hands and then touching ones face or other body part to spread infectious vectors. If ones immune system is weak or compromised, this in turn may lead to illness and the spread of further infection to family members or loved ones. Having quick access to a sanitizing agent to disinfect ones hands could reduce the risk of this infectious threat. By utilizing alcohol as the sanitizing agent due to its low viscosity, high evaporation rate and minimal amount needed for sanitizing, it can be easily dispensed from the wrist band squeezable cells. In addition, to minimize dryness, moisturizers arc added to each squeezable cell. Please note: regular hand washing should still be the main choice for hygiene; but, this application will provide a quick sanitizing means in the event one is unable to hand wash.

(2) Description of Related Art Including Information disclosed Under 37 CFR 1.97 and 1.98

Not Applicable

### G. BRIEF SUMMARY OF THE INVENTION

The present embodiment of this application is an adjustable wrist band with individual cells utilized to provide a sanitizing treatment to ones hands, which contain sanitizing compounds of alcohol, sanitizing agents and moisturizers. These individual cells can contain the same or varying agents, which are squeezed from the cells directly onto the hands. These wrist bands are disposable and only utilized until the eight cells on the inner ring have been used up. This will provide an extra level of hygiene as the wristband is not reused once all eight cells have been expelled. Only minimal sanitizing fluid in needed to achieve adequate sanitation of one's hands. The outer ring can be imprinted with graphics, corporate logos, safety messages or utilization instructions prior to joining the two rings together with the outer ring having the printed text or graphics and the inner ring containing the calls with sanitizing agent. This bi-layer assembly and application is unique from any prior designs.

### H. BRIEF DESCRIPTION OF THE SEVERAL VIEWS OF THE DRAWING(S)

See Drawings Sheet

FIG. 1 is a top view pictorial diagram of the basic form of the application wrist band sanitizing device showing the outer (printable) ring and inner (sanitizing eight cell dispenser) ring.

FIG. 2 is a top view pictorial diagram of the basic form of the application wrist band sanitizing device inner ring highlighting the inner ring eight segmented cells, which hold the sanitizing liquid.

FIG. 3 is a side view pictorial diagram of the application wrist band sanitizing inner ring, which holds the single use cells of sanitizing liquid.

FIG. 4 is a side view pictorial diagram of the application wrist band sanitizing device outer ring (transparent here to show inner ring detail), which will have text or graphical images to facilitate application and use.

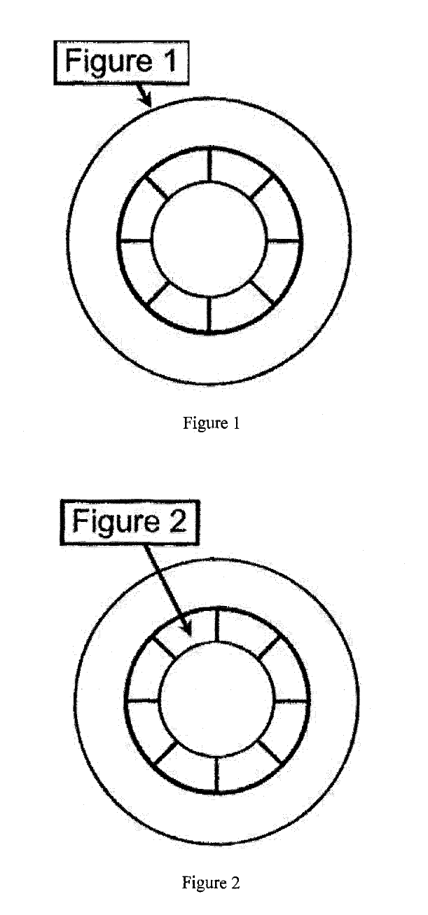

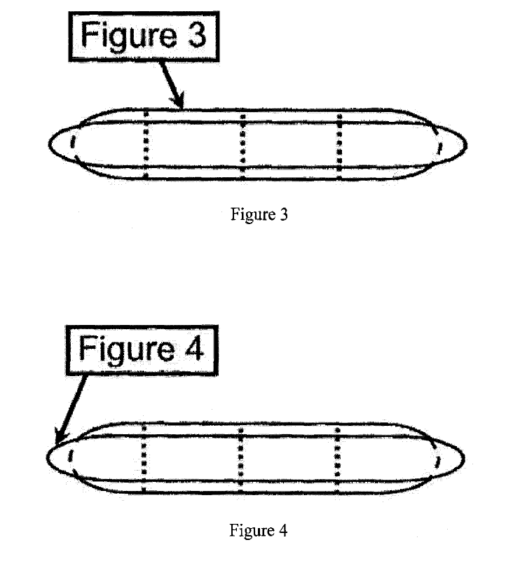

The following definitions will help clarify drawing descriptions:

Ring refers to elastic and resilient band that can stretch and return to original form around ones wrist. Adjustable straps are optional for small children with adult supervision. Cells refer to the small single use manually squeezable sections that allot sanitizing liquid to ones hands.

### DETAILED DESCRIPTION OF THE INVENTION

The present application will provide quick sanitizing hand treatments in a readily accessible and disposable wrist bracelet (to enhance sanitation) to ones hands. This is beneficial due to the minimal toxicity of liquid and low viscosity over the temperature range of application plus its sanitizing benefits. This facilitates the squeezing of any given sanitizing cell located on the bracelet onto the skin. In this trouble-free cell design, the cell expels the sanitizer with minimal force to the cell directly to ones hands. No special nozzles or bladders, as in prior applications are needed, allowing for reduced cost, increased simplicity and a diminished potential for malfunction. The application is a combination of two rings, an inner and outer with each manufactured separately and joined in the middle by strong adhesive. The composition of the application is designed to be convenient to use. The application can be used for all ages, with children's bracelets embossed with various fun, sport or comic graphics or even family logos. On the other hand, the bracelet may contain text or images to provide instruction on application utilization or other text as requested from corporations and end users.

The sanitizer would contain 60-70% alcohol, sanitizing agents and moisturizer as a solution of pure alcohol would dry the skin due to its rapid evaporation. Sanitizing agents may include, but are not limited to the following: Allicin, Benzalkonium chloride, Benzethonium chloride, Benzoic acid, Benzyl alcohol, Bromochlorophene 2-Bromo-2-nitropropane-1,3-diol, Butylparaben, Capryloyl collagen amino acids, Capryloyl glycine, Capryloyl keratin amino acids, Captan, Cetethyldimonium bromide, Cetyl pyridinium chloride, Chlorothymol, Chloroxylenol, Citral, Copper PCA, Dichlorobenzyl alcohol, Dilauryldimonium chloride, Domiphen bromide, Ethylparaben, Eucalyptus globulus extract, Fennel (Foeniculum vulgare) extract, Garlic (Allium sativum) extract, Gentian violet, Glyceryl caprylate, Glyceryllaurate, Hexamidine diisothionate, Hexetidine, Hinokitiol, Honeysuckle (Lonicera caprifolium) extract, Leptospermum scoparium oil, Lichen (Usnea barbata) extract, Methylparaben, Myristalkonium chloride, Pentylene glycol, Pfaffia paniculata extract, Phenethyl alcohol, Phenol, Phenoxyethanol, Phenoxyisopropanol, Phenyl mercuric acetate, Phenyl mercuric benzoate, Phenyl mercuric borate, o-Phenylphenol, Phytosphingosine, Piroctone olamine, Polymethoxy bicyclic oxazolidine, Potassium sorbate, Propylparaben, Sage (Salvia officinalis) extract. Sodium benzoate, Sodium pyrithione, Sodium ricinoleate, Sodium shale oil sulfonate, Tea tree (Melaleuca alternifolia) oil. Thimerosal, Thyme (Thymus vulgaris) extract, Thymol, Triclocarban, Triclosan, Undecylenic acid, Zinc oxide, Zinc PCA, Zinc pyrithione, Zinc undecylenate, Aluminum PCA, Ammonium iodide, Butylglucoside caprate, Caprylic/capric glycerides, Chlorhexidine, Chlorhexidine diacetate, Chlorhexidine digluconate, Chlorhexidine dihydrochloride, Chlorphenesin, alpha-Glucan-oligosaccharide, Lactoferrin, Lauralkonium bromide, Lauralkonium chloride. Laurtrimonium chloride, Laurylpyridinium chloride, Philodendron (Phellodendron amurense) extract, Sodium usnate, Undecylenic acid, docosanol, eicosanol and mixtures thereof. Moisturizers may include, but are not limited to the following: Aloe gel, Aloe vera oil, Avocado extract/oil, Babassu oil, Black currant extract/oil, Brazil nut oil, Camellia japonica oil, Canola oil, Cashew nut oil, liquid soy extract, Corn oil, Cottonseed oil, Cucumber extract, beeswax, Evening primrose, Grape seed oil, Hazel nut oil, Honey extract, Jojoba butter, Jojoba oil, Kiwi extract, Mango seed oil, Mineral oil, Olive oil, Orange extract, Palm oil, Palmetto extract, Shea butter, Soybean oil, Spirulina, Sunflower seed oil, Vegetable oil, Walnut oil and mixtures thereof. The sanitizer would be created by combining various quantities of alcohol, sanitizing agents and moisturizers.
This application will improve hand sanitization as it can be economically distributed throughout Schools, Governmental Agencies, Court Room, Shopping Malls and other Business due to its simplistic design and easy application. Its flexibility will encourage improved sanitizing as described above. However, although these descriptions illustrate the application embodiments, it is understood that those skilled in design may modify this design. Any such modification to this application that generally falls within its description should be included.

### J. CLAIM OR CLAIMS (commencing on a separate sheet)

See Claims Sheet

### K. ABSTRACT OF THE DISCLOSURE (commencing on a separate sheet)

See Abstract Sheet

L. SEQUENCE LISTING (See MPEP §2424 and 37 CFR 1.821-1.825. A “Sequence Listing” is required on paper if the application discloses a nucleotide or amino acid sequence as defined in 37 CFR 1.821(a) and if the required “Sequence Listing” is not submitted as an electronic document on compact disc)

Not Applicable

1. An elastic/adjustable wrist band that holds an inner ring of multiple individual sanitizing cells for discharging individually (as needed) to one's hands to sanitize and prevent or minimize infection.

2. The wristband can be utilized with or without available hand washing and is intended to provide a quick supplemental means of decreasing potential infection for the wearer. Squeezing one of the cells will dispense a single treatment to ones hands, which contain alcohol, sanitizing agents and moisturizer.
